(19) United States
(12) Patent Application Publication
(10) Pub. No.: US 2013/0054825 A1
(43) Pub. Date: Feb. 28, 2013

(54) CONTENT STREAMING IN COMMUNICATION SYSTEM

(71) Applicants: Russell D. Mareachen, Winfield, IL (US); Sek M. Chai, Streamwood, IL (US)

(72) Inventors: Russell D. Mareachen, Winfield, IL (US); Sek M. Chai, Streamwood, IL (US)

(73) Assignee: GENERAL INSTRUMENT CORPORATION, Horsham, PA (US)

(21) Appl. No.: 13/279,967

(22) Filed: Oct. 24, 2011

Related U.S. Application Data
(60) Provisional application No. 61/526,305, filed on Aug. 23, 2011.

(51) Int. Cl. G06F 15/16

(52) U.S. Cl. 709/231

(57) ABSTRACT

A multi-media device comprising a controller configured to determining that media presented on a multimedia interface will be subject to starvation based on a rate at which a stream of data is received and a rate at which the media is presented on a multimedia interface of the device. The controller also configured to interrupt the presentation of media on the multimedia interface and to present supplemental content on the multimedia interface starvation occurs, to buffer data from the stream of data while presenting the supplemental content, and to present media on the multimedia interface based at least partly on the buffered data after presentation of the supplemental content.

### CROSS-REFERENCE TO RELATED APPLICATIONS

The present application claims benefits under 35 U.S.C. 119(e) to U.S. provisional Application No. 61/526,305 filed on 23 Aug. 2011, the contents of which are incorporated herein by reference.

### FIELD OF THE DISCLOSURE

The present disclosure relates generally to the presentation of media on a multimedia device and, more particularly, to presenting supplemental content on a user interface of the multimedia device when a stream of data from which the media is obtained is inadequate to support uninterrupted presentation of the media on a user interface of the device.

### BACKGROUND

In many urban areas, broadband wireless communications networks capable of streaming content to mobile users are emerging at an unprecedented rate. The prevalence of broadband communications networks and advances in digital rights management has spurred the distribution of content to an extent heretofore unknown. Consumer demand for broadband services is currently insatiable. Operators are currently adopting data and rate-based billing strategies to prioritize the allocation of limited bandwidth among subscribers. At least in the near term, broadband-based services will in all likelihood be subject to periods of limited network capacity due to excessive demand, which may adversely affect the ability of networks to stream data a rates sufficient to support uninterrupted consumption by consumers. The rata at which data is received by a multimedia device may also vary for other reasons including, but not limited to, deterioration in signal quality. These and other factors may also have an adverse affect on the continuity of the user experience as it relates to the presentation of content at a user interface of both wire-line and wireless devices.

The various aspects, features and advantages of the invention will become more fully apparent to those having ordinary skill in the art upon careful consideration of the following Detailed Description with the accompanying drawings described below. The drawings may have been simplified for clarity and are not necessarily drawn to scale.

### BRIEF DESCRIPTION OF THE DRAWINGS

FIG. 1 illustrates a system of communication networks over which content may be distributed to multimedia devices.

FIG. 2 illustrates block flow diagram.

FIG. 3 illustrates schematic block diagram of multimedia device.

### DETAILED DESCRIPTION

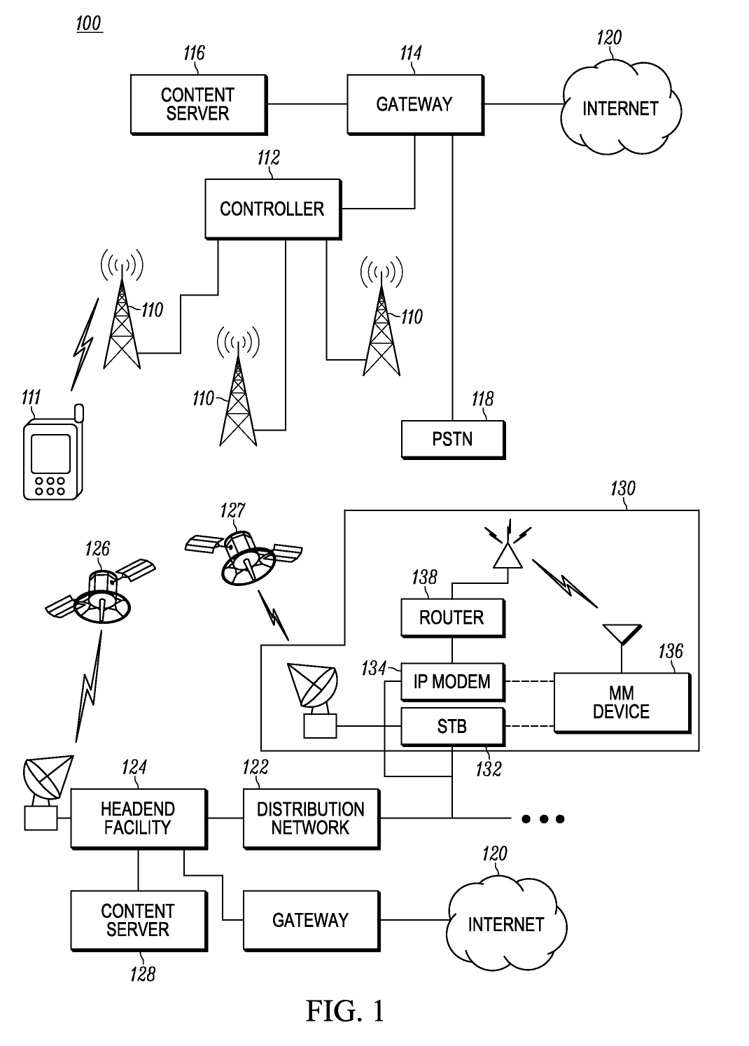

In FIG. 1, a system 100 of communication networks over which content may be distributed to multimedia devices generally comprises a wireless communications network and a multi-system operator (MSO) network. While two separate types of networks are shown and described herein, the subject of the present disclosure is also applicable to cases where content is communicated to a single recipient multimedia device. As a practical matter however the multimedia device will most likely receive content via a communication network of some type. Thus the networks described herein are only examples of networks over which content may be distributed to one or more multimedia devices. Other types of networks may also be employed including but not limited to local area networks (LANs), wide area networks (WANs), and satellite networks, among others.

In FIG. 1, the wireless communication network is embodied as a cellular communications network comprising a plurality of base stations 110 that provide service over corresponding and somewhat overlapping geographical areas commonly referred to as cellular areas or cells. Multiple base stations are generally controlled by a controller 112, the combination of which constitutes a radio access network (RAN). The RAN is generally communicably coupled to a core network (CN) that includes a gateway 114 interconnecting the RAN to other networks like a Public Switched Telephone System (PSTN) 118, the Internet 120 among other networks. The core network may also be coupled to content servers 116 directly, via the gateway 144 as illustrated, or via another network like the Internet. The core network also has other features and functions that are well known to those having ordinary skill in the art but that are not discussed further herein.

Wireless network protocols capable of providing data at rates suitable for streaming content to user terminals include, but are not limited to, the 3rd Generation Partnership Project (3GPP) Universal Mobile Terrestrial System (UMTS) protocol, the 3GPP Long Term Evolution (LTE) protocols, the IEEE 802.11 protocols, the IEEE 802.16 protocols among other existing and future wireless communication protocols. As suggested above, streaming data to a multimedia device over a wireless communication network of any type may be subject to data rate reducing signal interruptions that may result in discontinuities in presentation of content or media at a user interface of the multimedia device based on the received content stream. The user interface of the multimedia device may also be referred to as a multimedia interface. Such interruptions or reductions in the data rate may result from network congestion, signal fading, receiver desensitization, among other factors.

In FIG. 1, the MSO network is implemented as a terrestrial cable network comprising generally a fiber or cable distribution network 122 communicably coupled to a headend facility 124, which communicates with other entities, like a system of geosynchronous satellites 126. The headend facility may be coupled to one or more other networks via a gateway or via a satellite link. The headend facility may also be coupled to one or more content servers 128 directly as shown, via satellite link, or via some other network. More generally, the MSO network has other features and functions that are well known to those having ordinary skill in the art but that are not discussed further herein. Alternatively, the MSO may be embodied as a satellite system operator that provides content and network access to users or subscribers via a system of satellites that transmit signals received directly by subscribers, rather than a terrestrial cable distribution network.

In FIG. 1, a wireless communication multimedia device 111 communicates and receives content over the wireless communication network. The user of such a device is typically registered to the network as a subscriber, but some wireless networks may be accessible without a subscription. The device may be embodied as a smart phone, a tablet or browsing device, a laptop or other portable computing device and even a fixed base computer with wireless communication capability or any other multimedia capable device having wireless communication capabilities. FIG. 1 also illustrates a subscriber 130 coupled to the MSO network. If the MSO is a satellite system operator the subscriber or user terminal would communicates wirelessly via satellite 127. If the MSO is a cable operator the subscriber device communicates via the terrestrial distribution network. In either case, the MSO subscriber or user 130 includes either a set top box (STB) 132 or an Internet Protocol (IP) or other communications modem 134 coupled to or integrated with a multimedia device.

In FIG. 1, the STB is typically coupled to a television or other video monitor, designated generally as a multimedia device 136. The video monitor and STB are typically integrated with a discrete audio system, although in some embodiments the monitor may include audio. Alternatively, the STB and the television or monitor may be considered to be the multimedia device. The STB generally enables reception of downlink (DL) signals by the tuner or receiver of the STB, television or video monitor. For example, the STB may enable reception of digital signals, or perform descrambling of content, for example premium cable or satellite channels. Some set top boxes also perform signal conversion to enable reception of signals that would otherwise be outside a frequency band of the tuner. These and other functional features of set top boxes are known generally and thus the details thereof are not described further herein. As suggested above, the functionality of the STB may be integrated with the television or monitor. Thus the subscriber may receive and consume streamed content via the STB and monitor. Here too however, the streamed data is susceptible to interruptions or rate variations that may disrupt the continuity media presented at the user interface. Such interruptions may result from network traffic among other reasons as discussed above. In embodiments where the MSO is a satellite operator, the interruptions streamed data rate may result from adverse weather conditions that interfere with the downlink signal.

In FIG. 1, the communication modem 134 is typically coupled to a multimedia device, which may be embodied as a tablet, browsing device, computer, networked television, or other device, also designated generally as multimedia device 136. In some implementations, the modem 134 is coupled to a wireless router 138 that communicates wirelessly with the multimedia device. A networked television may be coupled to both the STB and the IP modem. In any case, the streamed content received by the multimedia device is susceptible to interruptions or data rate variations that may disrupt the continuity of the media or content presented at the multimedia device. Interruptions in the streamed data rate may result from traffic on the satellite or terrestrial network to which the communication modem 134 is connected. In implementations where the multimedia device 136 is coupled to the modem via a wireless router or access point 138, rather than a direct wire-line connection, interruptions in the delivery of streamed data may result from traffic on the wireless network or from interference with the wireless signal.

According to one aspect of the disclosure, interruptions or imminent interruptions in the presentation of media or content at the user interface of the multimedia device, for whatever reasons, are compensated by presenting supplemental content as described more fully below. Here, such an interruption may result from a discontinuity in the streamed data or from a variation, usually in the form of a reduction, in the rate at which the streamed data is delivered to or received by the multimedia device. The supplemental content is different than the media presented. The supplemental content may be advertising or marketing material, public service information, network information, news flash, weather report, or any other information. In some embodiments, the content is related to the media or content obtained from the streamed data. Compensation refers to continuity in the presentation of some content at the user interface for consumption by the user, rather than subject the user to an interval of no content. Thus while there is a discontinuity in the presentation of a specified media, the user is presented with other content rather than no content at all. Thus media starvation rate, from whatever cause (e.g., network traffic, signal strength reduction, etc.), provides an opportunity to present alternative or supplemental content to the user.

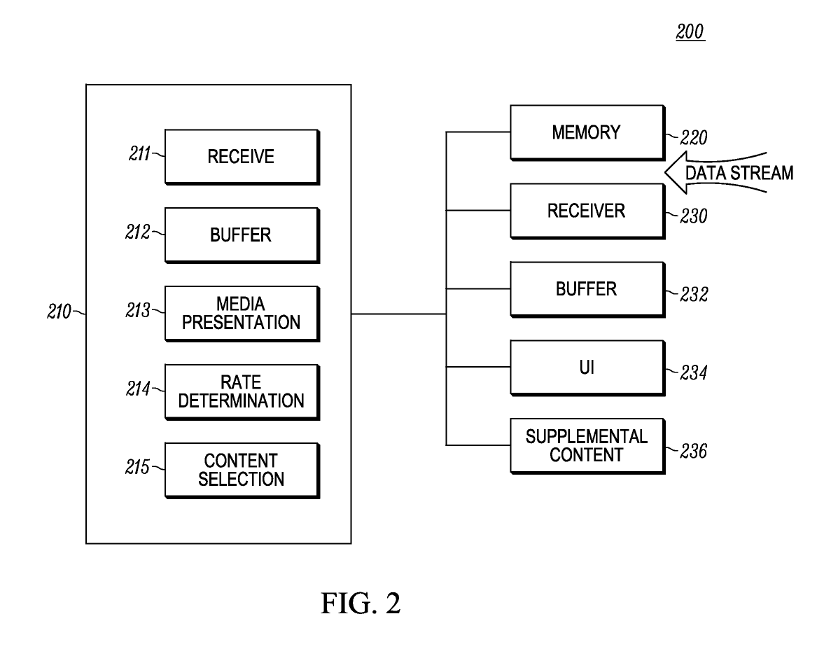

FIG. 2 is a schematic block diagram of a multimedia device 200 capable of receiving a stream of data from a broadband network or from some other source, examples of which are described above. In FIG. 2, the multimedia device includes a controller 210 that implements various features and functions described further below. The controller is readily implemented using a digital processor that executes instructions stored in firmware or in some other memory device, which is illustrated generically as memory device 220. Alternatively, the controller may be implemented using equivalent hardware circuits or using a combination of software and hardware elements.

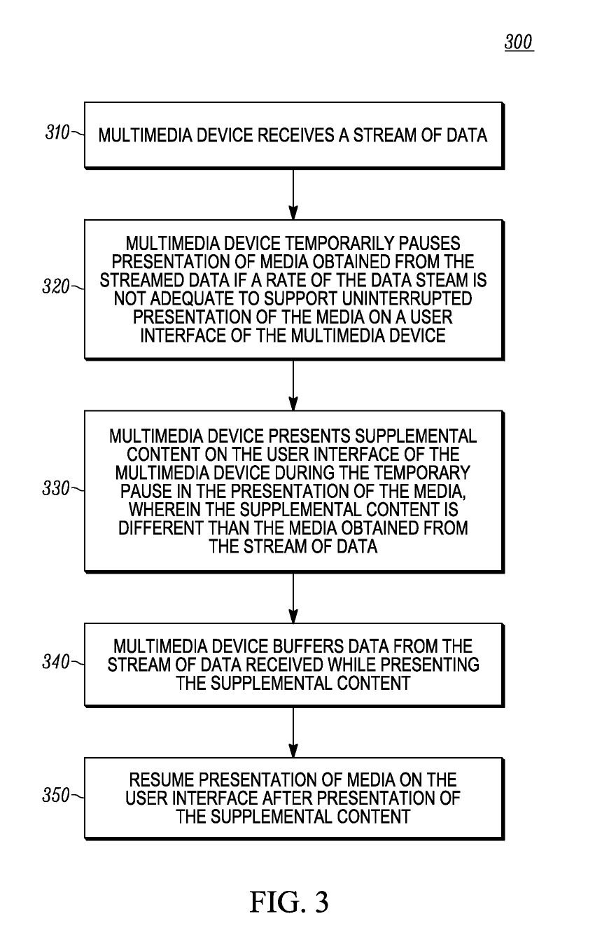

In the process flow diagram of FIG. 3, at block 310, a multi-media device receives a stream of data and presents content or media on a user interface of the multimedia device based on the stream of data received. In FIG. 2, the multimedia device includes a receiver 230 for receiving the stream of data. The received data is typically stored in a buffer 232 prior to presentation on a user interface 234 like a video monitor. The user interface may be implemented as a visual display and/or an audio interface. In some embodiments, the multimedia device includes a transmitter configured to transmit uplink communications. The device also includes functionality 211 that controls the receiver and in some embodiments the transmitter. In devices that buffer data before presentation on the user interface, the device also includes buffer control functionality 212. The device includes media presentation functionality 213 that controls the presentation of media on the user interface. The receive control, buffering, and media presentation functions are readily implemented using a digital processor. Alternatively these functions may be implemented using equivalent analog circuits or a combination of analog and digital circuits.

In FIG. 3, at 320, the multimedia device temporarily pauses the presentation of media on the user interface of the multimedia device if a rate at which the stream of data is received is inadequate to support uninterrupted presentation of the media on the user interface. The interruption to the media presentation may be immediate or imminent. An imminent interruption is an interruption that will occur within a specified time period or interval. In FIG. 2, the multimedia device thus includes data rate determination functionality 214 that determines a rate at which the source stream is received and a rate at which the corresponding media is played back or presented. With this rate information, the device may determine whether media starvation will occur and may also predict when starvation will occur. The rate determination and media presentation control functionality are readily implemented using a digital processor. Alternatively, these functions may be implemented using equivalent analog circuits or a combination of analog and digital circuits.

In one embodiment, the multimedia device determines that a rate at which the stream of data is received is not adequate to support uninterrupted presentation of media obtained from the stream of data at a future time. According to this embodiment, the presentation of media obtained from the data is temporarily paused before starvation occurs. Supplemental content is presented on the user interface of the multimedia device during the interval during which the media is temporarily paused. The media presentation functionality 213 also controls presentation of the supplemental content. Meanwhile, the device continues to receive the stream of data, which may continue to be buffered during the presentation of the supplemental content. In other implementations, temporarily pausing the presentation of media includes delaying the initial presentation of media based on a determination that an initial data rate is insufficient to support sustained media presentation of the user interface. In this instance, the data stream received at the multimedia device may be buffered during the presentation of the supplemental content. The media may be presented on the user interface after there is sufficient buffering of data to sustain uninterrupted presentation of the media for at least a reasonable interval of time, after which additional supplemental content may be presented.

In FIG. 3, at 330, the multimedia device presents supplemental content on the user interface of the multimedia device during the temporary pause in the presentation of the media, wherein the supplemental content is different or other than the media obtained from the stream of data. In some embodiments, the supplemental content is buffered before presentation on the user interface. In FIG. 2, the supplemental content is stored in memory 236, for example, in RAM, and may be buffered prior to presentation in the user interface 234. The supplemental content may be buffered using a dedicated buffer or it may be buffered with the data received in the stream of data.

In one embodiment, the supplement content is obtained from a source other than the stream of data received by the receiver. For example, the supplemental content may be stored locally and obtained when required from local memory. The locally stored content is generally received by the receiver or downloaded and stored on the device prior to it use. For example, a network operator, like an MSO, may push advertisements or public service announcements to subscriber devices, which store the supplemental content for later use. Alternatively, the supplemental content may be transferred to and stored on the multimedia device manually using a memory stick or some other media. In another embodiment, the supplemental content may be transferred wirelessly using a wireless interface, like WiFi or Bluetooth or some other wireless protocol receiver other than the receiver on which the stream of content is received. Generally, regardless of its source, the supplemental content is or will have been obtained by the device such that the supplemental content may be used to compensate for discontinuities in the presentation of content or media derived from fluctuations in the data stream.

In yet another embodiment, the supplemental content is received by another receiver on the multimedia device from a source other than the source from which the stream of data is received by the receiver. For example, the stream of data may be received over a cellular link and the supplemental content may be received over a WiFi link or other local area network. According to this scenario, the stream of data received over the cellular link may be subject to data rate variations that result in the starvation of the media presented on the user interface. The supplemental data received over the WiFi link may be used to compensate for data starvation experienced on the cellular link. Other multimedia devices may have other multi-network communication capabilities. For example, a television that presents media from streamed data received by a cable or satellite STB may also be connected to the Internet by a wireless or wire-line interface.

In one implementation, the supplemental content is selected from among a plurality of different supplemental contents stored in memory of the multimedia device. The supplemental content selection may be based on a variety of different criteria depending on the intent or objective of the particular application. For example, the supplemental content may be selected from among a plurality of different supplemental contents stored in memory of the multi-media device based at least in part on a characteristic of the media. Such a selection may be made to present related or complementary subject matter. In other embodiments, the selection may be based on user profile information including viewing and purchasing interests, location, a among many other user attributes. User profile based selection is particularly suitable for applications where the supplemental content is advertising. In FIG. 2, the device includes supplemental content selection functionality 215. The selection function is readily implemented using a digital processor. Alternatively this function may be implemented using equivalent analog circuits or a combination of analog and digital circuits.

In one embodiment, the multimedia device estimates a duration for which the received data stream is not adequate to support uninterrupted presentation of the media obtained from the stream of data. Such a determination may be made based on the data rate and conservative predications on the future data rate as suggested above. According to this embodiment, the presentation of media is temporarily paused for at least the estimated duration. In one implementation, the supplemental content is selected based at least in part on a duration for which the stream of data is not adequate to support uninterrupted presentation of the media obtained from the stream of data.

In FIG. 3, at 340, the multimedia device buffers data from the stream of data received while presenting the supplemental. At 350, the multimedia device resumes presentation of media on the user interface of the multi-media device after pausing presentation of media, and after presentation of the supplemental content, wherein at least some of the media presented after pausing is obtained from the buffered data.

In one particular implementation, the multimedia device requests streaming of a media title. Such a request may be made at a user interface of the device. For example, such a request may be made upon selection of on-demand content via an electronic program guide (EPG), which is commonly employed in various STB devices. Alternatively, such content may be selected from a content portal, URL or website, like NETFLIX, among many other sources of such content. The multimedia device determines a rate of media playback and a rate of the source stream. If the rate at which data is streamed to the device is lower than the rate at which media is played back or presented on the user interface, the multimedia device inserts a targeted advertisement in presentation on the user interface before media starvation. Meanwhile, during presenting targeted advertising on the user interface, the multimedia device buffers the streamed data. The point at which the targeted advertising is inserted into the media is based at least partly on timing considerations to ensure continuity of the presentation of the media and supplemental content on the user interface. In other words, the supplemental content is inserted prior to media starvation.

Alternatively, the insertion point for the supplemental content may be based on some other criteria. In one embodiment, the supplemental content insertion point is based on an analysis of the media to be presented on the user interface. For example, the insertion point could occur when during an image transition or during a transition in change in the audio characteristic component of the multimedia presentation. Scene changes may be determined by sampling and analyzing frames associated with the media to be presented.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a multi-media device, the method comprising:
receiving a stream of data at the multi-media device;
temporarily pausing presentation of media obtained from the stream of data if a rate of the stream of data is not adequate to support uninterrupted presentation of the media on a user interface of the multimedia device;
presenting supplemental content on the user interface of the multimedia device during the temporary pause in presentation, wherein the supplemental content is other than media obtained from the stream of data; and
buffering data from the stream of data received while presenting the supplemental content.

2. The method of claim 1 further comprising:
determining that media presented on the user interface of the multimedia device will be subject to starvation based on a rate at which the stream of data is received and a rate at which the media is presented on the user interface; and
temporarily pausing presentation of media before starvation.

3. The method of claim 1 further comprising:
presenting media, obtained from the stream of data, on the user interface of the multimedia device while receiving the stream of data before pausing the presentation of media;
resuming presentation of media on the user interface of the multi-media device after pausing presentation of media, wherein at least some of the media presented after pausing is obtained from the buffered data.

4. The method of claim 3,
determining that a rate at which the stream of data is received is not adequate to support uninterrupted presentation of media obtained from the stream of data at a future time,
temporarily pausing presentation of media obtained from the data before the future time.

5. The method of claim 1, temporarily pausing the presentation of the media includes delaying an initial presentation of media obtained from the stream of data until after presenting the supplemental content.

6. The method of claim 1 further comprising obtaining the supplement content from a source other than the stream of data.

7. The method of claim 6 further comprising receiving the supplemental content presented before receiving the stream of data and storing the supplemental content in memory of the multimedia device.

8. The method of claim 1 further comprising:
determining a duration for which the stream of data is not adequate to support uninterrupted presentation of the media obtained from the stream of data;
temporarily pausing the presentation of media for at least the duration determined.

9. The method of claim 8 further comprising selecting the supplemental content from among a plurality of different supplemental contents stored in memory of the multimedia device.

10. The method of claim 9 further comprising selecting the supplemental content based at least in part on the duration for which the stream of data is not adequate to support uninterrupted presentation of the media obtained from the stream of data.

11. The method of claim 1 further comprising:
determining a characteristic of the media obtained form the stream of data;
selecting the supplemental content from among a plurality of different supplemental contents stored in memory of the multi-media device, the selection based at least in part on the characteristic of the media.

12. A multi-media device comprising:
a receiver;
a multimedia interface;
a buffer;
a controller coupled to the receiver, the multimedia interface and the buffer,
the controller configured to determining that media presented on the multimedia interface will be subject to starvation based on a rate at which a stream of data is received by the receiver and a rate at which the media is presented on the multimedia interface,
the controller configured to interrupt the presentation of media on the multimedia interface and to present supplemental content on the multimedia interface starvation occurs,
the controller configured to buffer data from the stream of data in the buffer while presenting the supplemental content, and
the controller configured to present media on the multimedia interface based at least partly on the buffered data after presentation of the supplemental content.

13. The device of claim 12, the controller configured to further comprising obtaining the supplement content from a source other than the stream of data.

14. The device of claim 12 further comprising memory storing a plurality of different supplemental contents, the controller configured to select the supplemental content from among the plurality of different supplemental contents.
